(19) United States
(12) Patent Application Publication
(10) Pub. No.: US 2005/0135612 A1
(43) Pub. Date: Jun. 23, 2005

(54) Secure digital communication

(76) Inventor: Alan F. Evans, Beaver Dams, NY (US)

Correspondence Address: CORNING INCORPORATED, SP-TI-3-1, CORNING, NY, 14831, US

(21) Appl. No.: 10/741,212

(22) Filed: Dec. 19, 2003

(51) Int. Cl. H04L 9/00

(52) U.S. Cl. 380/43

(57) ABSTRACT

A secure digital data transmission technique in which a transmitter and a receiver, are connected by two or more transmission channels, preferably carried on separate optical fibers. The transmitter includes a switch operable to divide a datastream to be transmitted into segments each comprising from a few tens to a few thousand data bits and allocating adjacent said segments always to different said transmission channels. Delays may be introduced so that the divided datastreams arrive at the receiver in correct temporal relation, or the separate received datastreams may be stored and interleaved subsequently. The switch may operate periodically or according to a key. Gaps are preferably infilled with random or unrelated data.

### BACKGROUND OF THE INVENTION

1. Field of the Invention

The present invention relates generally to digital communications, and particularly to a method of and apparatus for transmitting digital data securely in the sense that the risk of an eavesdropper being able to detect the data is low. It is especially, but not exclusively, applicable to digital optical communication over optical fibers. The technique of the invention can be used by itself or in addition to known encryption techniques, according to the level of security required.

2. Technical Background

Ordinary optical communication fibers, if they can be accessed, are relatively easy to tap without detection, because a quite small degree of bending is sufficient to allow a minor proportion of the signal light to escape the confinement of the fiber and be diverted to a detector—the technique is legitimately used by communication utilities to monitor and manage signal traffic.

Security against eavesdropping is usually obtained by encrypting the data using an appropriate mathematical algorithm, which will normally require either a secret key known to both sender and receiver of the data or two keys, one of which is secret and known only to the receiver and the other of which need not be secret because reversal of the encryption process (without use of the secret key) requires so much computation as to be impracticable on any realistic time-scale—or at least this is the belief of the users of the algorithm.

Alternatively, the data may be transmitted by light pulses of very low intensity (corresponding to a fraction of a quantum of light per pulse) so that an eavesdropper cannot detect all the pulses, but will inevitably cause frequent detectable data errors, and this “quantum cryptography” technique enables security to be achieved by randomization of transmission and subsequent non-secret identification of the received digits to be read, but is limited in the distance over which it is reliable.

The “code division multiple access” technique used in digital cell-phone systems and its optical analog provide a high standard of security by transmitting individual data pulses by different channels (in the optical case, possibly either wavelength- or time-division multiplexed channels), but this demands very precise matching of transit times in the different channels to allow the signals to be re-assembled correctly.

There thus remains a need for a secure communication technique in which the use of keys is not essential, which can be transmitted by optical pulses intense enough to travel long distances, with regeneration en route if required, and which is tolerant of transit time variations.

### SUMMARY OF THE INVENTION

One aspect of the invention is a method for secure transmission of digital data which comprises dividing the data into segments each comprising from a few tens to a few thousands of data bits, transmitting adjacent such segments to a receiver always by different transmission channels selected from two or more pre-arranged transmission channels, and interleaving the segments in their original order at the receiver.

In another aspect, the present invention includes a secure digital data transmission installation comprising a transmitter and a receiver, at least two transmission channels for conveying digital signals from said transmitter to said receiver, wherein said transmitter includes a switch operable to divide a datastream to be transmitted into segments each comprising from a few tens to a few thousand data bits and allocating adjacent said segments always to different said transmission channels.

In principle, the transmission channels can be of any type, for example wavelength- or time-division multiplexed or unmultiplexed channels on electrical wire pairs or coaxial cables or on optical fibers or radio channels of any appropriate frequency and modulation type, and the use of channels of different types is not excluded, though it is likely to make interleaving more difficult than if all the channels are of the same kind. It is also possible to use channels that use different transmission media in different parts of their length. More especially, we prefer that each of the channels is an optical one carried on an optical fiber. Two or more channels multiplexed on the same fiber could be used, but it is very much preferred that the channels (or at least some of them) are carried by separate fibers and for the greatest security they should reach the receiver by physically different routes.

The segment lengths may be equal or unequal, and may be freely chosen within constraints determined by the facts that short segments become more difficult to interleave correctly and very long ones may begin to compromise security by containing useful data within them. Our present preference is that the segments comprise 2⁴ to 2¹³, more especially 2⁵ to 2¹⁰ and most preferably 2⁶ to 2⁹ bits

Any kind of optical switch can be used to separate the segments of an optical datastream and allocate each of them to the appropriate channel, provided the format and bit-rate of the data is consistent with it. If the data is in a continuous stream, only a very fast optical switching operation can avoid losing pulses at the interfaces of the segments: preferably the switching interval should be less than a tenth of the bit rate. A Mach-Zehnder interferometer switch is recommended, or an electroabsorption modulator or a semiconductor optical amplifier can be used in combination with a splitter. If the data is in, or can be organized into, packets with sufficiently large gaps between them, even a micro-mechanical switch might be usable by arranging for change of the switching state to occur always within gaps.

When the datastream is received or generated in electrical form, it is possible and may often be preferable to separate the segments by means of a suitably fast electrical switch and then modulate the channels separately onto respective optical carriers.

An alternative approach to avoiding limitations from the operating speed of optical switch(es) is to use a splitter and two separate switches operating at slightly different times, so that the new channel is opened and functional before the closing channel begins to be switched off; damaged or duplicated portions of the signal can be identified and discarded at the receiver.

The transit time of the channels used for the transmission of the data will, in general, differ substantially, and in some cases unpredictably, and this will need to be allowed for in organizing the interleaving at the receiver. Interleaving in real time can be achieved, at least in favorable cases, by measuring the difference in transit time (“pinging the system”, for example), if necessary at frequent intervals, and introducing an equal relative delay at the transmitter in the datastream sent by the faster route(s), so that the pulses arrive in correct temporal relation at the receiver.

Alternatively, the signals received by the different channels may be stored, at least for a short period, and interleaved as a subsequent step. This option will usually require the transmitted signals to carry some timing data that enables the correct interleaving sequence to be determined. This could be as little as a single short segment (including even a single pulse of different format or modulation type) in each channel recording its own absolute or relative transmission time—for greatest ease of use, at the beginning of the transmission; or for maximum security, anywhere else but at the beginning. Alternatively, when the data is organized in packets, at least some of them may include addressing information that identifies a sequential packet number.

Preferably, the gaps between the segments in at least one of the channels (or at least some of those gaps) are preferably infilled, wholly or in part, with random or unrelated data, so that the segments to be interleaved are not easily identified. Such unrelated data might, for example, comprise segments of a different transmission being made securely by the techniques of this invention. Without such infilling, an eavesdropper may be able to reconstruct certain kinds of data (natural language, for example) from the data transmitted by one of the channels only (usually, that is, from half the data); or in the improbable but not always impossible situation that an eavesdropper can identify and tap both (or all) the channels being used, infilling is needed to avoid making interleaving very easy to achieve. Further additional security may be achieved by varying the routes by which the segments are sent (when more than two routes are used) and/or their lengths (when infilling is used) according to a key that is either pre-arranged or is notified to the user subsequently or contemporaneously by an appropriately secure means.

The data to be transmitted may already have been encrypted by other means.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

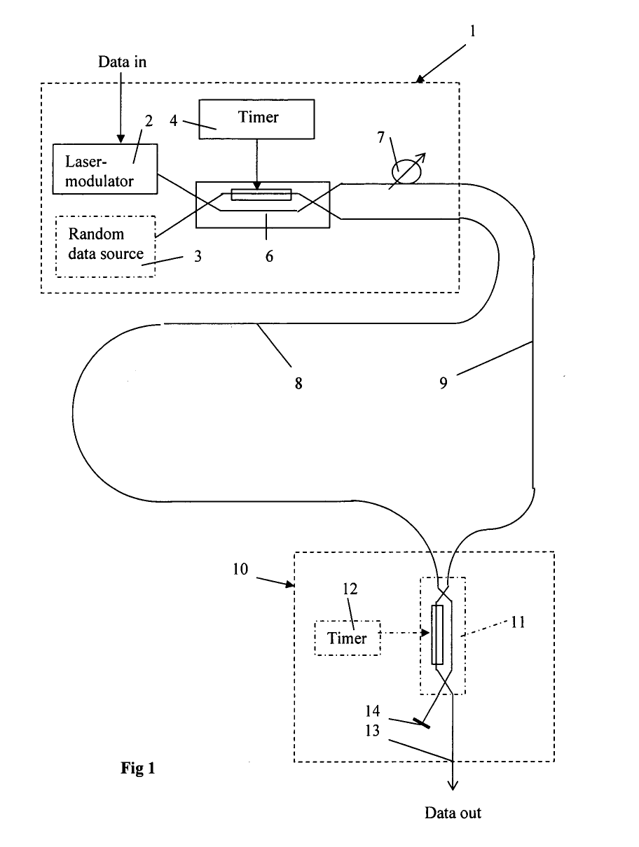

Each of FIGS. 1-4 is a diagram of a respective embodiment of the present invention and FIG. 5 illustrates a modification to the first embodiment.

### DETAILED DESCRIPTION OF THE PREFERRED EMBODIMENTS

Whenever possible, the same reference numbers will be used throughout the drawings to refer to the same or like parts.

FIG. 1 shows the invention in one of the simplest possible forms, in order to illustrate its principles. In outline, a transmitter 1 communicates data securely to a receiver 10 using two optical fibers 8 and 9 having physically different routes, fiber 8 being longer, and therefore having a greater transit time for data, than fiber 9. For the purpose of illustration, the data source is assumed to be a laser-modulator 2 receiving the data to be transmitted as an electrical signal (typically at a bit rate corresponding to a microwave frequency) and modulating it onto an optical carrier - other sources can of course be used. Apart from the source, the transmitter 1 may comprise just a 4-port Mach-Zehnder modulator 6 and a timer 4 which at appropriate intervals changes its bias voltage so as to switch the output of the entering data between its two output ports and so divide the datastream into segments and allocate them alternately to fiber 8 or fiber 9, plus a delay 7 adjusted to compensate for the difference in transit time between the two fibers, which is in this example assumed to be known and stable, so that the arrival time of data pulses at the receiver 10 is independent of which route they were allocated to. In this very basic form of the invention, the receiver 10 may comprise no more than a coupler in which the two incoming datastreams are merged onto a single output fiber, so interleaving the segments in their original order.

Substantially greater security can be achieved by connecting a random data source 3 to the other input port of the modulator 2, so that there will always be output at both ports—that is the gaps between signal segments passing each of the fibers 8 and 9 will be infilled with random data. It is, of course, preferable for the random data source to be synchronized to the data so that the switching points will be difficult to identify. When this is done, the receiver 10 needs to discard the random data, and for this purpose comprises a 4-port Mach Zehnder modulator 11 (preferably substantially the same as the one in the transmitter) controlled by a timer 12 which switches bias at times appropriately related to those of the timer 4 in the transmitter so that the signal data pulses always arrive at the data output 13 and random data pulses always at 14 where they are discarded. The switching intervals may be uniform, in which case the necessary synchronization between timers 4 and 12 can be achieved simply by transmitting a reference time signal in advance of the first data segment (and refreshing from time to time, if the stability of the timers makes it desirable).

FIG. 2 shows a second embodiment of the invention, in which data is assumed to reach the transmitter 1 already in the form of a digital optical signal, which is immediately directed to a 1×n optical splitter 15 (n being a small whole number, say from 2 to about 32, but preferably not more than about 8) and so to an array 16 of n optical switches, which may be electroabsorption modulators or semiconductor optical amplifiers operated in switching mode, under the control of a key encoder 17 such that only one of the switches is normally in “on” mode at any time. The output of the switch array may be received initially by a ribbon of parallel fibers and can then be separated to reach the receiver 10 by diverse routes or packaged within the same cable. No attempt is made to synchronize the arrival of the data at the receiver, and data arriving by each route is detected separately by a detector array 18 and directed to a memory buffer 18. A decoder/sequencer 20 is either pre-programmed to know the sequence to be applied by the key encoder, or is informed of it by any suitably secure data link 21, and also takes account of the transit times of the different data routes and is thus enabled to read data from the buffer 19 at the appropriate times and interleave it to reconstitute the input data. Such resequencing algorithms are used in TCP/IP protocol used in today's internet and will not be described further. With values of n in the upper part of the preferred range (or higher), this embodiment may provide adequate security without infilling the gaps, because the risk of an eavesdropper successfully tapping all the diverse routes is small, and even if he does, he will not know the correct relative timing and it will take substantial effort to discover it. Nevertheless, infilling can be used and will substantially increase the level of security achievable.

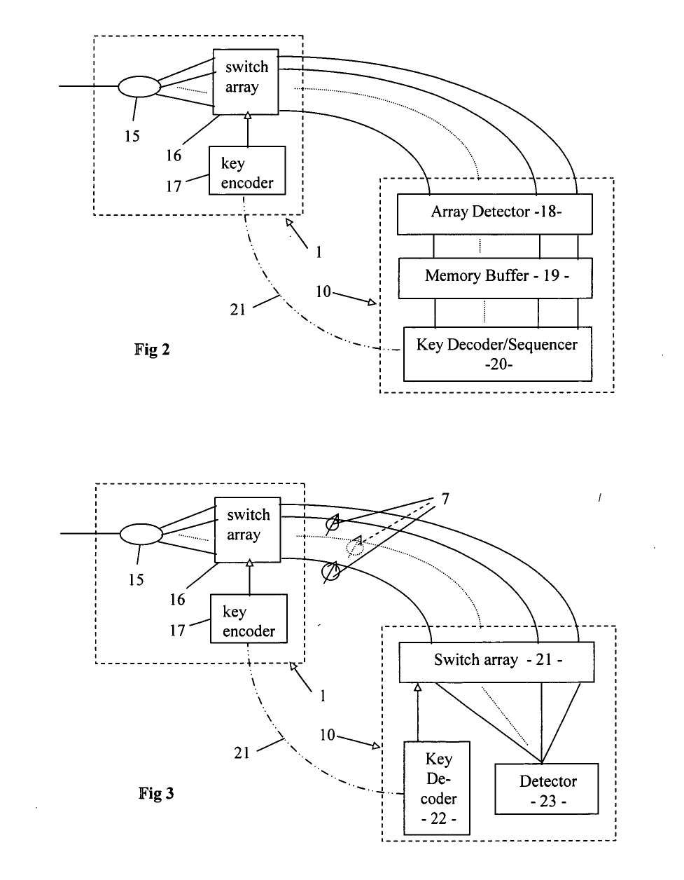

In the embodiment of FIG. 3, the transmitter may be substantially the same as in that of FIG. 2, but delays 7 are provided to synchronize the arrival of data at the receiver from the diverse routes and infilling of gaps is preferably provided in a manner (not shown) that will be readily understood from the description of FIG. 1 above. A switch array 21 controlled by a key decoder 22 is thus enabled to direct and interleave the data so that a single detector 23 can be used. Without data infilling, the switch array 21 could be replaced by a simple n×1 optical coupler.

In a first modification of the embodiment of FIG. 3, the delays 7 could be located at the receiver, upstream of the switch array 21. In a second modification, optical delays could be placed at both the transmitter (Oust after the switch array) and at the receiver (Oust in front of the switch array). Especially (but not exclusively) in configurations where all fiber paths are within the same cable, this would allow additional security by adding delays not known to an eavesdropper that would make interleaving the data segments even more difficult.

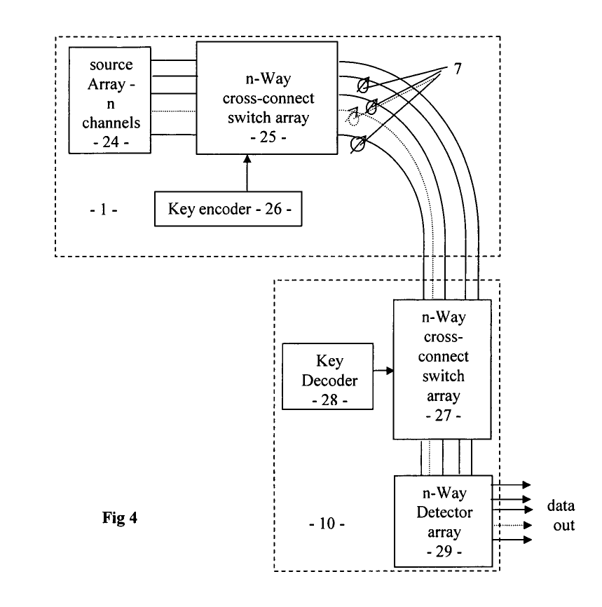

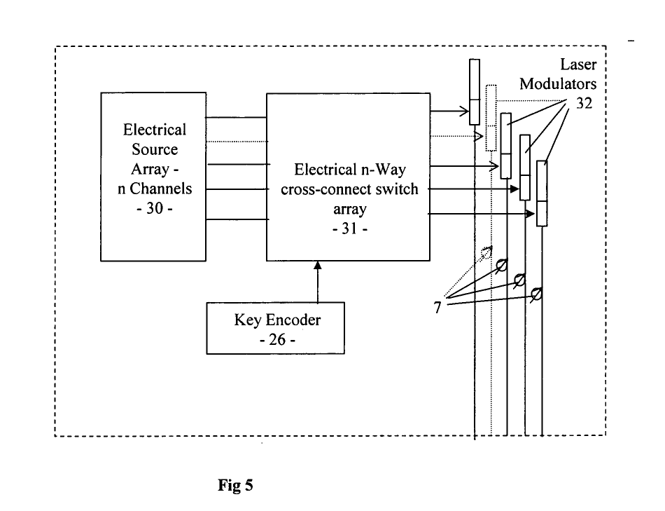

The embodiment of FIG. 4 is broadly similar to that of FIG. 3, but provides for the simultaneous secure transmission of multiple datastreams from the transmitter 1 to the receiver 2; these datastreams may come from any type of source (including different types) within or outside the transmitter, but need to be synchronized. The splitter and switch array of the FIG. 3 apparatus are replaced by a multi-channel cross-connect switch 25 which is operated by key encoder 26 to allocate segments of each incoming datastream to different ones of the diverse fiber routes, but so that each route is always carrying a datastream. In the receiver 10, a similar cross-connect switch 27 is correspondingly operated by a key decoder 28 so as to interleave the segments of the original datastreams, each onto a respective output, from which they may pass to a multi-channel detector array 29. With this arrangement, the fibers are efficiently utilized and no random data source is needed unless one or more of the channels would otherwise be idle. Even if an eavesdropper were able to get access to every one of the fiber routes it would be near to impossible to correctly interleave any of the datastreams without knowledge both of the sequence imposed by encoder 26 and known to decoder 28 and of the time differences between his access points.

FIG. 5 shows an alternative transmitter that can be substituted directly for transmitter I in the embodiment of FIG. 4. An electrical source array 30 provides n channels of input data which are supplied directly to an electrical cross-connect switch 31 with the same number of ways, which is controlled by the key encoder 26 to interleave them; the output ways of the cross-connect switch are taken to respective laser-modulators 32 which modulate their data onto respective optical carriers. Delays 7 and the receiver may be exactly as before, and the modifications described in relation to FIG. 4 remain applicable.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

Any discussion of the background to the invention herein is included to explain the context of the invention. Where any document or information is referred to as “known”, it is admitted only that it was known to at least one member of the public somewhere prior to the date of this application. Unless the content of the reference otherwise clearly indicates, no admission is made that such knowledge was expressed in a printed publication, nor that it was available to the public or to experts in the art to which the invention relates in the US or in any particular country (whether a member-state of the PCT or not), nor that it was known or disclosed before the invention was made or prior to any claimed date. Further, no admission is made that any document or information forms part of the common general knowledge of the art either on a world-wide basis or in any country and it is not believed that any of it does so.

1. A method for secure transmission of digital data which comprises dividing the data into segments each comprising from a few tens to a few thousands of data bits, transmitting adjacent such segments to a receiver always by different transmission channels selected from two or more pre-arranged transmission channels, and interleaving the segments in their original order at the receiver.

2. A method in accordance with claim 1 in which each said channel is an optical one carried on an optical fiber.

3. A method in accordance with claim 1 in which at least some said channels are carried by separate fibers which reach the receiver by physically different routes.

4. A method in accordance with claim 1 in which each said segment comprises 2⁴ to 2¹³ bits.

5. A method in accordance with claim 1 in which each said segment comprises 2⁵ to 2¹⁰ bits.

6. A method in accordance with claim 1 in which each said segment comprises 2⁶ to 2⁹ bits.

7. A method in accordance with claim 1 comprising using an optical switch to separate said segments and allocate each of them to the appropriate said channel.

8. A method in accordance with claim 7 in which said optical switch has a switching interval less than a tenth of the bit rate of said digital data.

9. A method in accordance with claim 7 in which said optical switch is a Mach-Zehnder interferometer switch.

10. A method in accordance with claim 7 in which said optical switch is selected from an electroabsorption modulator and a semiconductor optical amplifier and is used in combination with a splitter.

11. A method in accordance with claim 1 comprising using an electrical switch to separate said segments and allocate each of them to the appropriate said channel.

12. A method in accordance with claim 11 in which each said channel is afterwards modulated onto an optical carrier.

13. A method in accordance with claim 1 comprising measuring the difference in transit time between said channels and introducing an equal relative delay at the transmitter in the datastream sent by the faster route, so that the pulses arrive in correct temporal relation at the receiver.

14. A method in accordance with claim 1 comprising storing signals received by the different said channels and interleaving them as a subsequent step.

15. A method in accordance with claim 14 in which the transmitted signals carry some timing data that enables the correct interleaving sequence to be determined.

16. A method in accordance with claim 15 in which said timing data is a single segment in each channel recording its own transmission time.

17. A method in accordance with claim 15 in which said data is organized in packets and at least some of them include addressing information that identifies a sequential packet number.

18. A method in accordance with claim 1 in which gaps between said segments in at least one of the channels are at least partly infilled with data selected from random and unrelated data.

19. A method in accordance with claim 18 in which said segments are of varying lengths according to a key.

20. A method in accordance with claim 1 in which more than two said channels are used and in which the channels used vary according to a key.

21. A method for secure transmission of digital data which comprises dividing the data into segments each comprising from a few tens to a few thousands of data bits, transmitting adjacent such segments to a receiver always by different transmission channels selected from two or more pre-arranged transmission channels each carried on a respective optical fiber, and interleaving the segments in their original order at the receiver.

22. A method in accordance with claim 21 in which each said respective optical fiber reaches said receiver by a different physical route.

23. A secure digital data transmission installation comprising a transmitter and a receiver, at least two transmission channels for conveying digital signals from said transmitter to said receiver, wherein said transmitter includes a switch operable to divide a datastream to be transmitted into segments each comprising from a few tens to a few thousand data bits and allocating adjacent said segments always to different said transmission channels.

24. A secure digital data transmission installation in accordance with claim 23 in which each said channel is selected from wavelength- or time-division multiplexed and unmultiplexed channels on media selected from electrical wire pairs, coaxial cables and optical fibers, and from radio channels.

25. A secure digital data transmission installation in accordance with claim 23 in which each said channel is an optical channel carried on an optical fiber that reaches said receiver by a physically different route.

26. A secure digital data transmission installation in accordance with claim 23 in which each said segment comprises 2⁴ to 2¹³ bits

27. A secure digital data transmission installation in accordance with claim 23 in which each said segment comprises 2⁵ to 2¹⁰ bits

28. A secure digital data transmission installation in accordance with claim 23 in which each said segment comprises 2⁶ to 2⁹ bits.

29. A secure digital data transmission installation in accordance with claim 23 in which said switch is a Mach-Zehnder interferometer switch.

30. A secure digital data transmission installation in accordance with claim 23 in which said switch is selected from an electroabsorption modulator and a semiconductor optical amplifier and is used in combination with a splitter.

31. A secure digital data transmission installation in accordance with claim 23 in which said switch is an electrical switch and the signal in each channel is subsequently modulated onto an optical carrier.

32. A secure digital data transmission installation in accordance with claim 23 in which said transmission channels include at least a faster channel and a slower channel and said transmitter includes a delay in the datastream sent by said faster channel, so that the pulses may arrive in correct temporal relation at the receiver.

33. A secure digital data transmission installation in accordance with claim 23 in which said receiver includes means for storing the signals received by the different channels and interleaving them as a subsequent step.

34. A secure digital data transmission installation in accordance with claim 23 in which said transmitter includes a source of data selected from random and unrelated data for at least partly infilling gaps between said segments in at least one of said channels.

35. A secure digital data transmission installation comprising a transmitter and a receiver, at least two separate optical fibers each providing a respective transmission channel for conveying digital signals from said transmitter to said receiver, wherein said transmitter includes a switch operable to divide a datastream to be transmitted into segments each comprising from a few tens to a few thousand data bits and allocating adjacent said segments always to different said transmission channels.

36. A secure digital data transmission installation in accordance with claim 35 in which each of said optical fibers reaches said receiver by a physically different route.
